(19) United States
(12) Patent Application Publication
(10) Pub. No.: US 2018/0224284 A1
(43) Pub. Date: Aug. 9, 2018

(54) DISTRIBUTED AUTONOMOUS MAPPING

(71) Applicant: Robert Bosch GmbH, Stuttgart (DE)

(72) Inventor: Kevin M. Danford, Ann Arbor, MI (US)

(21) Appl. No.: 15/425,662

(22) Filed: Feb. 6, 2017

(51) Int. Cl. G01C 21/32; G01S 19/45; G01S 19/46; G06F 17/30

(52) U.S. Cl. CPC G01C 21/32; G06F 17/30241; G01S 19/46; G01S 19/45

(57) ABSTRACT

A method and system for updating geoinformatic data. In one example, the method includes determining, with an electronic processor, a geographic area of interest and determining whether a vehicle is within the geographic area of interest based on a location signal received from the vehicle. The method also includes transmitting to the vehicle a request to upload sensor data and receiving the sensor data from the vehicle. A portion of the geoinformatic data is updated within a map database based on the sensor data. The portion is associated with the geographic area of interest.

### FIELD

Embodiments relate to navigation systems for vehicles.

### BACKGROUND

Some vehicles are equipped with a global positioning system (GPS) that provides a location of the vehicle based on GPS coordinates. These vehicles may be equipped with a navigation system that provides the location of the vehicle with reference to a map displayed in the vehicle. The navigation system may also include information relating to the location of the vehicle. For example, the navigation system may display a map with various features of the roadway being travelled and points of interest near to that location.

However, the navigation system may provide information that is outdated or incorrect due to changes in the roadway or due to changes in the points of interest. In this way, current systems do not accurately depict rapidly changing conditions. These changing conditions may range from roadway construction, traffic pattern changes, infrastructure updates, etc. In order to update a map to reflect new changes/events, a mapping company or mapping service would need to deploy equipment and personnel to a specific area to perform mapping operations, update the data in their maps, and then download the new data to required vehicles in the affected area. This approach is limited by the ability to respond rapidly, efficiently, and cost effectively. Realistically, mapping equipment and personnel cannot be deployed rapidly to all locations where changes are occurring. Additionally, completing detailed and regularly updated maps of rural and other areas of relatively low traffic is likely to be low priority to mapping companies due to the time and cost required.

In the case of autonomous or semi-autonomous vehicles, the location information and information relating to the location of the vehicle is provided directly to the vehicle itself. The autonomous vehicle then uses this information for navigation and for use by passengers in the vehicle. Vehicle navigations systems can detect traffic slowdowns and reroute a planned trip due to construction or other unforeseen events. However, without updated maps, the autonomous vehicle may be unable to remain in a fully autonomous state without some driver intervention to deal with unaccounted changes in the infrastructure.

### SUMMARY

Sensor systems on autonomous vehicles that are currently owned/operated by the public may be selectively activated based on areas of identified interest and used to generate mapping data to process and update the mapping services for distribution to all vehicles in the affected area.

One embodiment provides a method of updating geoinformatic data. The method includes determining, with an electronic processor, a geographic area of interest and determining whether a vehicle is within the geographic area of interest based on a location signal received from the vehicle. The method also includes transmitting to the vehicle a request to upload sensor data and receiving the sensor data from the vehicle. The method further includes updating a portion of the geoinformatic data within a map database based on the sensor data. The portion of the geoinformatic data is associated with the geographic area of interest.

Another embodiment provides a central server for updating geoinformatic data. The central server includes a map database and an electronic processor communicatively connected to the map database. The electronic processor is configured to determine a geographic area of interest and determine whether a vehicle is within the geographic area of interest based on a location signal received from the vehicle. The electronic processor is further configured to transmit to the vehicle a request to upload sensor data and to receive the sensor data from the vehicle. The electronic processor is still further configured to update a portion of the geoinformatic data within the map database based on the sensor data. The portion of the geoinformatic data is associated with the geographic area of interest.

Other aspects, features, and embodiments will become apparent by consideration of the detailed description and accompanying drawings.

### BRIEF DESCRIPTION OF THE DRAWINGS

FIG. 1 is a block diagram of system for updating geoinformatic data according to one embodiment.

FIG. 2 is a block diagram of a controller of a central server of the system of FIG. 1 according to one embodiment.

FIG. 3 is a block diagram of an electronic control unit of a vehicle of the system of FIG. 1 according to one embodiment.

FIG. 4 is a flowchart of a method of updating geoinformatic data using the system of FIG. 1 according to one embodiment.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

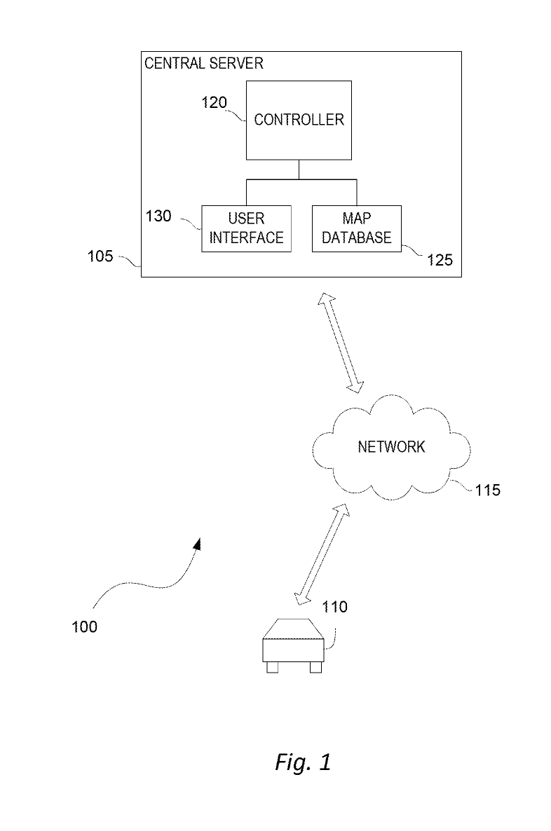

FIG. 1 provides an illustrative example of a system 100 for updating geoinformatic data. In the example illustrated, the system 100 includes a central server 105, a vehicle 110, and a network 115. The central server 105 is communicatively connected to the vehicle 110 during operation of the system 100 via the network 115. The network 115 may operate using various types of communication protocols and mechanisms. For example, the network 115 may enable communications with a wide area network, the internet, cellular communications, and others. Similarly, the vehicle 110 may encompass various types and designs. For example, the vehicle 110 may be an automobile, a truck, a bus, a semi-tractor, and others. The vehicle 110 may, in some embodiments, be semi-autonomous or fully autonomous. For the sake of discussion, only a single vehicle is described within this disclosure. However, during operation of the system 100, the central server 105 may handle communications from multiple vehicles simultaneously or in rapid succession and capture sensor data from the multiple vehicles.

In the illustrated example, the central server 105 includes a controller 120, a map database 125, and a user interface 130. The controller 120 may be communicatively connected to the map database 125 and the user interface 130 via various wired or wireless connections. For example, in some embodiments, the controller 120 is directly coupled via a dedicated wire to each of the above-listed components of the central server 105. In other embodiments, the controller 120 is communicatively coupled to one or more of the components via a shared communication link such as a wide area network.

The map database is a depository of information for navigation systems. For example, the map database 125 includes roadway information such as location, direction, curvature, slope, lanes, speed limits, embankments, dividers, bridges, and others. The roadway information may assist the vehicle with autonomous driving functions. The map database 125 also includes points of interest such as businesses, addresses, landmarks, and others. The map database 125 may also include information that is transitory such as information about construction zones and traffic patterns.

The user interface 130 is a mechanism for outputting information and receiving inputs from an operator of the central server 105. In some embodiments, the user interface 130 includes computer peripherals such as a keyboard, a display, a mouse, and others. The user interface 130 is configured to display information from the map database 125 to an operator. For example, the user interface 130 may display a map of a location with information associated with that location. The map may be the same or similar to a map that is displayed on the navigation system of the vehicle 110. The user interface 130 is configured to receive a selection from the operator at least partially defining a geographic area of interest. For example, the user interface 130 may accept a selection that defines a perimeter of the geographic area of interest. The selection may be traced on the map and enclose a geographic area of a various shape or size. The selection indicates to the controller 120 what portions of the geoinformatic data needs updating. In some embodiments, the selection may simply identify a single location point on the map, a range of the geographic area of interest, or both. In these embodiments, the controller 120 determines the geographic area of interest based at least partially on the input on the user interface 130. In some embodiments, as discussed further below, the controller 120 using an electronic processor automatically determines the geographic area of interest based on the geoinformatic data stored within the map database 125.

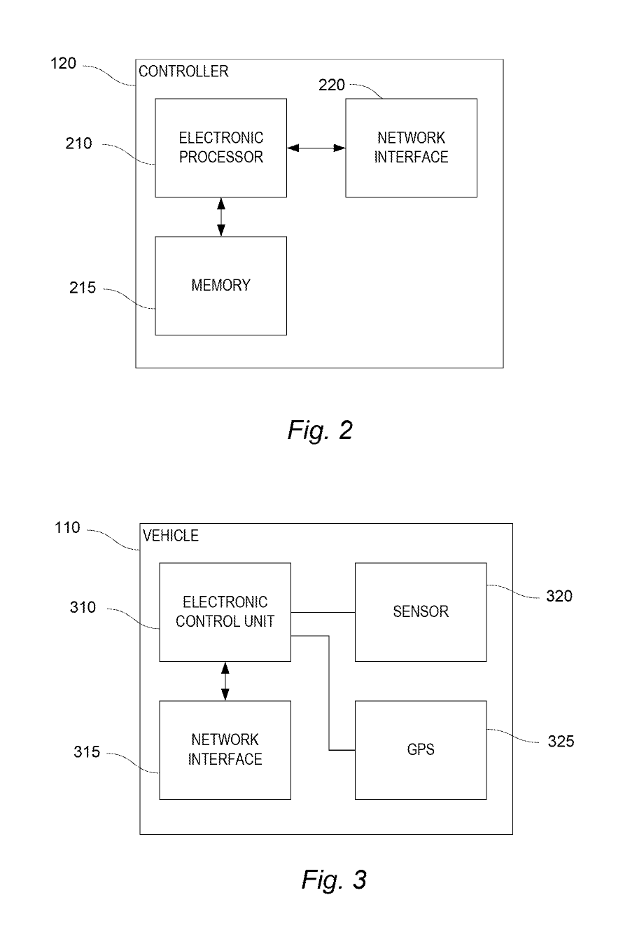

Details of the controller 120 according to one embodiment are illustrated in FIG. 2. The controller 120 includes a plurality of electrical and electronic components that provide power, operation control, and protection to the components and modules within the controller 120. In the illustrated example, the controller 120 includes, among other things, an electronic processor 210 (such as a programmable electronic microprocessor, microcontroller, or similar device), a memory 215 (for example, non-transitory, machine readable memory), and a network interface 220. The electronic processor 210 is communicatively connected to the memory 215 and the network interface 220. The electronic processor 210, in coordination with the other components, is configured to implement, among other things, the methods described herein. For example, the network interface 220 establishes communications with the vehicle 110 via the network 115, and the electronic processor 210 processes sensor data received from the vehicle 110.

The controller 120 may be implemented in several independent controllers (for example, programmable servers) each configured to perform specific functions or sub-functions. Additionally, the controller 120 may contain sub-modules that include additional electronic processors, memory, or application specific integrated circuits (ASICs) for handling input/output functions, processing of signals, and application of the methods listed below. In other embodiments, the controller 120 includes additional, fewer, or different components

FIG. 3 provides an illustrative example of the components of the vehicle 110 relating to the system 100. In the example illustrated, the vehicle 110 includes an electronic control unit 310, a network interface 315, at least one sensor 320, and a global positioning system (GPS 325). The electronic control unit 310, among other things, controls the routing of sensor data and external communications with the central server 105. In some embodiments, the electronic control unit 310 is included as part of a navigation system of the vehicle 110. The electronic control unit 310 is communicatively connected to the sensor 320 and is configured to receive sensor data from the sensor 320. The electronic control unit 310 is also communicatively connected to the GPS 325 and receives location information from the GPS 325. The electronic control unit 310 may be configured to transmit the sensor data, the location information, vehicle identifying data, and time of transmission to the central server 105 via the network interface 315. In some embodiments, the electronic control unit 310 includes an electronic processor (such as a programmable electronic microprocessor, microcontroller, or similar device) and a memory 215 (for example, non-transitory, machine readable memory) that in conjunction control transmission of the sensor data to the network 115.

The sensor 320 is illustrated, for the sake of discussion, as a single sensor. However, the sensor 320 is intended to include multiple various sensing devices and components on the vehicle 110. For example, the sensor 320 may include an optical camera, stereo cameras, a radio detection and ranging (RADAR) sensor, a light detection and ranging (LIDAR) sensor, an ultrasonic sensor, an infrared sensor, or any combination of the foregoing. As such, the sensor 320 is configured to sense multiple spectrums for information indicative of position, distance, and relative speed of objects and infrastructure. In some embodiments, the sensor 320 receives transmissions (for example, radio frequency communications) from other vehicles indicative of distance, relative speed, and location of other vehicles and objects. For example, in these embodiments, the sensor 320 may use vehicle-to-vehicle (V2V) communication technology to obtain or supplement detection. Various sensor processing techniques may determine distance, relative speed, location, and other parameters regarding the surroundings of the vehicle 110 prior to transmission to the central server 105.

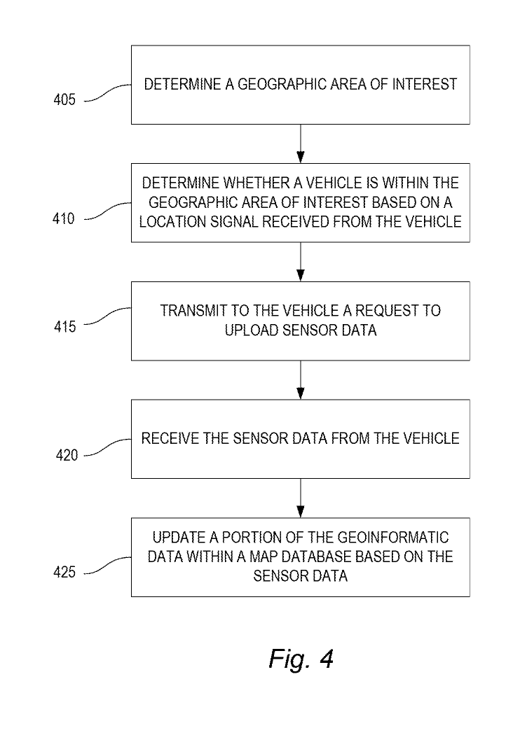

FIG. 4 illustrates a method of updating geoinformatic data stored within the map database 125 of the central server 105 according to one embodiment. In the illustrated example, the electronic processor 210 determines a geographic area of interest (block 405). The geographic area of interest may be of various shapes and sizes. For example, the geographic area of interest may be determined by defining a center location (for example, defined by GPS coordinates) and a distance from center, by defining a perimeter surrounding the geographic area of interest, or by selecting a previously identified geographic area (for example, by a zip code). The geographic area of interest may be determined by various techniques including automatically by the electronic processor 210 or by manual selection on the user interface 130.

In some embodiments, the geographic area of interest is automatically or manually determined based on a status of the geoinformatic data. In this case, the electronic processor 210 may first select a portion of the geoinformatic data in which to perform an update and then select the geographic area that is associated with that portion of the geoinformatic data. For example, the electronic processor 210, or an operator of the central server 105, may analyze the geoinformatic data in the map database 125 and determine whether portions of the geoinformatic data are incomplete (for example, data relating to a location with a newly constructed roadway). The geoinformatic data may also be analyzed to determine if it is outdated (for example, the geoinformatic data may be outdated if it has not been updated for a certain period of time). In some embodiments, the electronic processor 210 automatically selects the geographic area of interest based on when the portion of the geoinformatic data that is associated with the geographic area of interest was previously updated. For example, the electronic processor 210 may select the geographic area of interest associated with the portion of the geometric data that has the longest time interval since the last update. The geoinformatic data may also be analyzed to determine if it is incorrect. For example, this may occur when errors or inconsistencies are found by the electronic processor 210 in a portion of the geoinformatic data. When this occurs, the electronic processor 210 may select that portion of the geoinformatic data to update.

Once the geographic area of interest is determined, the electronic processor 210 then determines whether the vehicle 110 is within the geographic area of interest based on the location signal received from the vehicle 110 (block 410). The location signal may be generated by the vehicle 110 based on the GPS 325 within the vehicle 110. In some embodiments, the electronic processor 210 continuously receives the location signal at periodic intervals from the vehicle 110. In this case, the electronic processor 210 may track the position of the vehicle 110 prior to determination of the geographic area of interest. Then, once the geographic area of interest is determined, the electronic processor 210 determines whether the vehicle 110 is inside or outside of the geographic area of interest. In this way, the electronic processor 210 identifies all the vehicles that are within the geographic area of interest based on the location signals received from each of the vehicles. In some embodiments, the electronic processor 210 also identifies when vehicles enter into the geographic area of interest based on the location signal received from the entering vehicles.

After determining that the vehicle 110 is within the geographic area of interest, the electronic processor 210 transmits to the vehicle 110 a request to upload the sensor data (block 415). In some embodiments, transmitting the request occurs when the vehicle 110 is first determined to be within the geographic area of interest. For example, when the vehicle 110 is powered up or when communication between the vehicle 110 and the central server 105 is first established and the vehicle 110 is within the geographic area of interest, the central server 105 generates the request. In other embodiments, transmitting to the vehicle 110 the request to upload sensor data occurs when the vehicle 110 crosses the perimeter and enters into the geographic area of interest. In this case, communication with the central server 105 may have already been established.

Once the request is received, the vehicle 110 transmits the sensor data to the central server 105. However, in some embodiments, the vehicle 110 may first determine whether to share the sensor data based on a setting within the vehicle 110 (for example, a setting within the navigation system). For example, the vehicle 110 may opt-in or opt-out of sensor data sharing. By default, sensor data sharing may be enabled and thus, the vehicle 110 may immediately transmit the sensor data upon receiving the request from the central server 105. Once the transmission occurs, the central server 105 receives the sensor data from the vehicle 110 (block 420). As discussed above, the sensor data may include object information such as location, size, and position of roadway infrastructure including retaining walls, bridges, embankments, and others. The sensor data may also include information about construction zones, traffic patterns, and roadway conditions. As also indicated above, the sensor data may be generated by one or more radar sensors, lidar sensors, cameras, or a combination of the foregoing.

In some embodiments, the vehicle 110 transmits as the sensor data is generated by the sensor 320. In other embodiments, the vehicle 110 stores, in the electronic control unit 310, some or all of the sensor data and transmits the sensor data at periodic intervals to the central server 105. A location and time may be included with the sensor data during transmission to the central server 105. For example, the electronic control unit 310 may append a time stamp, GPS coordinates, or both to the sensor data on a periodic or continuous basis for transmission.

When the sensor data is received, the central server 105 updates a portion of the geoinformatic data within the map database 125 based on the sensor data (block 425). The portion of the geoinformatic data that is updated is associated with the geographic area of interest. For example, as sensor data is received, the central server 105 may correlate the sensor data with the portion of the geoinformatic data associated with that particular location based on the location signal received from the vehicle 110. In some cases, when the sensor data does not match the portion of the geoinformatic data corresponding to that particular location (for example, when the portion of the geoinformatic data is outdated), the central server 105 updates the geoinformatic data. However, in some embodiments, the central server 105 receives sensor data from multiple vehicles to confirm the changes before updating the geoinformatic data. In particular, the central server 105 may store sensor data from the vehicle 110 and wait until another vehicle gathers sensor data relating to the same location. In this case, when receiving sensor data from multiple vehicles, the central server 105 may compare the sensor data and update the geoinformatic data within the map database 125 based on an average or closest match.

Thus embodiments of the invention provide a system and a method of updating geoinformatic data based on sensor data from vehicles within a geographic area. Various features, advantages, and embodiments are set forth in the following claims.

1. A method of updating geoinformatic data, the method comprising:
determining, with an electronic processor, a geographic area of interest;
determining whether a vehicle is within the geographic area of interest based on a location signal received from the vehicle;
transmitting to the vehicle a request to upload sensor data;
receiving the sensor data from the vehicle, the sensor data including information of other vehicles and roadway infrastructure information; and
updating a portion of the geoinformatic data within a map database based on the sensor data, the portion being associated with the geographic area of interest.

2. The method according to claim 1, wherein determining, with the electronic processor, the geographic area of interest includes automatically selecting the geographic area of interest based on a status of the portion of the geoinformatic data.

3. The method according to claim 2, wherein automatically selecting the geographic area of interest based on a status of the portion of the geoinformatic data includes automatically selecting the geographic area of interest when the status of the portion of the geoinformatic data is at least one from the group consisting of incomplete, outdated, and incorrect.

4. The method according to claim 1, wherein determining, with the electronic processor, the geographic area of interest includes automatically selecting the geographic area of interest based on when the portion of the geoinformatic data that is associated with the geographic area of interest was previously updated.

5. The method according to claim 1, wherein determining, with the electronic processor, the geographic area of interest includes receiving a selection on a user interface that at least partially defines the geographic area of interest.

6. The method according to claim 5, wherein receiving the selection on the user interface that at least partially defines the geographic area of interest includes receiving a selection defining a perimeter of the geographic area of interest.

7. The method according to claim 6, wherein determining whether the vehicle is within the geographic area of interest based on the location signal received from the vehicle includes determining when the vehicle crosses the perimeter of the geographic area of interest.

8. The method according to claim 7, wherein transmitting to the vehicle the request to upload sensor data occurs when the vehicle crosses the perimeter of the geographic area of interest and enters into the geographic area of interest.

9. The method according to claim 1, the method further comprising receiving the location signal at periodic intervals from the vehicle, the location signal being generated by the vehicle based on a global positioning system within the vehicle.

10. The method according to claim 1, wherein receiving the sensor data from the vehicle includes receiving sensor data from at least one from the group consisting of a radar sensor, a lidar sensor, and a camera.

11. A central server for updating geoinformatic data, the central server comprising:
a map database; and
an electronic processor communicatively connected to the map database, the electronic processor configured to
determine a geographic area of interest,
determine whether a vehicle is within the geographic area of interest based on a location signal received from the vehicle,
transmit to the vehicle a request to upload sensor data,
receive the sensor data from the vehicle, the sensor data including object information about roadway infrastructure, and
update a portion of the geoinformatic data within the map database based on the sensor data, the portion being associated with the geographic area of interest.

12. The central server according to claim 11, wherein the electronic processor is further configured to automatically select the geographic area of interest based on a status of the portion of the geoinformatic data.

13. The central server according to claim 12, wherein the electronic processor is further configured to automatically select the geographic area of interest when the status of the portion of the geoinformatic data is at least one from the group consisting of incomplete, outdated, and incorrect.

14. The central server according to claim 11, wherein the electronic processor is further configured to automatically select the geographic area of interest based on when the portion of the geoinformatic data that is associated with the geographic area of interest was previously updated.

15. The central server according to claim 11, wherein the central server further comprises a user interface communicatively connected to the electronic processor, and wherein the electronic processor is further configured to receive a selection on the user interface that at least partially defines the geographic area of interest.

16. The central server according to claim 15, wherein the electronic processor is further configured to receive a selection defining a perimeter of the geographic area of interest.

17. The central server according to claim 16, wherein the electronic processor is further configured to determine when the vehicle crosses the perimeter of the geographic area of interest.

18. The central server according to claim 17, wherein the electronic processor is further configured to transmit the request to upload sensor data to the vehicle when the vehicle crosses the perimeter of the geographic area of interest and enters into the geographic area of interest.

19. The central server according to claim 11, wherein the electronic processor is further configured to receive the location signal at periodic intervals from the vehicle, the location signal being generated by the vehicle based on a global positioning system within the vehicle.

20. The central server according to claim 11, wherein the electronic processor is further configured to receive sensor data from at least one from the group consisting of a radar sensor, a lidar sensor, and a camera.
